(19) United States
(12) Patent Application Publication
(10) Pub. No.: US 2019/0016311 A1
(43) Pub. Date: Jan. 17, 2019

(54) Towelette with Wiping Element

(71) Applicant: Tammy Poteat, Honolulu, HI (US)

(72) Inventor: Tammy Poteat, Honolulu, HI (US)

(21) Appl. No.: 16/033,946

(22) Filed: Jul. 12, 2018

Related U.S. Application Data
(60) Provisional application No. 62/531,666, filed on Jul. 12, 2017.

(51) Int. Cl. B60S 3/04; B08B 1/00

(52) U.S. Cl. CPC B60S 3/04; B08B 1/005; B08B 1/006

(57) ABSTRACT

A towelette with wiping element for cleaning small targeted areas on the exterior surface of a vehicle. More specifically, the device is used to scrape congealed filth off of the exterior of a vehicle. The towelette includes a flexible absorbent cloth-like material with at least one wiping element attached along the edges or corners of the planar towelette. Additionally, the absorbent cloth-like material is designed to receive a cleaning solution to aid in the cleaning process.

### CROSS REFERENCE TO RELATED APPLICATION

This application claims the benefit of U.S. Provisional Application No. 62/531,666 filed on Jul. 12, 2017. The above identified patent application is herein incorporated by reference in its entirety to provide continuity of disclosure.

### BACKGROUND OF THE INVENTION

The present invention relates to bird droppings and other debris that commonly dirty the exterior surface of automobiles.

Vehicles with unclean exteriors are visually unappealing and can create bad impressions of the driver or owner. This is true even when the dirt or filth is limited to a few small areas on a car. Washing the entire car to address a few small unclean areas can be excessively costly, time consuming, and inconvenient for car owners. The present invention provides a quick, affordable, and convenient alternative for car owners looking to clean only a few small targeted areas of the exterior of their vehicles.

Devices have been disclosed in the known art that relate to automobile wipes. These include devices that have been patented and published in patent application publications. These devices have several known drawbacks. For example, these devices provide no additional means of scraping or removing dirt or debris that has congealed and firmly affixed itself to the exterior of a vehicle. Especially with regard to scraping congealed filth off of the body of the vehicle.

In light of the devices disclosed in the known art, it is submitted that the present invention substantially diverges in design elements from the known art and consequently it is clear that there is a need in the art for an improvement to existing automobile wiping devices. In this regard the instant invention substantially fulfills these needs.

### SUMMARY OF THE INVENTION

In view of the foregoing disadvantages inherent in the known types of automobile wipes now present in the known art, the present invention provides a new wiping blade wherein the same can be utilized for providing convenience for the user when scraping or removing dirt or debris that has congealed and firmly affixed itself to the exterior of a vehicle.

It is therefore an object of the present invention to provide a new and improved automobile wiping device that has all of the advantages of the known art and none of the disadvantages.

It another object of the present invention to provide a planar towelette comprised of a flexible absorbent cloth-like material, and at least one wiping blade disposed thereon.

Another object of he present invention is to provide a planar towelette having flexible absorbent material that is impregnated with a cleaning solution, or alternatively has been coated with a layer of cleaning solution.

A further object of the present invention is to provide a planar towelette having wiping blades disposed across the face, along the edges, or on the corner of the towelette.

An additional object of the present invention is to provide a plurality of planar towelettes that form a continuous roll, such that each towelette is removably attached to the roll.

Yet another object of the present invention is to provide an a towelette with wiping element that may be readily fabricated from materials that permit relative economy and are commensurate with durability.

Other objects features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of a supply of planar towelettes.

FIG. 2A shows a perspective view of an embodiment of a planar towelette with a wiping element disposed on the lower edge on both front and back faces.

FIG. 2B shows a front view of an embodiment of a planar towelette with a wiping element disposed on the lower edge on both front and back faces.

FIG. 2C shows a back view of an embodiment of a planar towelette with a wiping element disposed on the lower edge on both front and back faces.

FIG. 2D shows a left sideview of an embodiment of a planar towelette with a wiping element disposed on the lower edge on both front and back faces.

FIG. 2E shows a right sideview of an embodiment of a planar towelette with a wiping element disposed on the lower edge on both front and back faces.

FIG. 2F shows a lower edge sideview of an embodiment of a planar towelette with a wiping element disposed on the lower edge on both front and back faces.

FIG. 2G shows an upper edge sideview of an embodiment of a planar towelette with a wiping element disposed on the lower edge on both front and back faces.

FIG. 3A shows perspective view of an embodiment of a planar towelette with a wiping element on the lower edge on only the front face.

FIG. 3B shows a front view of an embodiment of a planar towelette with a wiping element on the lower edge on only the front face.

FIG. 3C shows a back view of an embodiment of a planar towelette with a wiping element on the lower edge on only the front face.

FIG. 3D shows a left sideview of an embodiment of a planar towelette with a wiping element on the lower edge on only the front face.

FIG. 3E shows a right sideview of an embodiment of a planar towelette with a wiping element on the lower edge on only the front face.

FIG. 3F shows a lower edge sideview of an embodiment of a planar towelette with a wiping element on the lower edge on only the front face.

FIG. 3G shows an upper edge sideview of an embodiment of a planar towelette with a wiping element on the lower edge on only the front face.

FIG. 4A shows perspective view of an embodiment of a planar towelette with a wiping element on the lower right corner on only the front face.

FIG. 4B shows a front view of an embodiment of a wiping element on the lower right corner on only the front face.

FIG. 4C shows a back view of an embodiment of a planar towelette with a wiping element on the lower right corner on only the front face.

FIG. 4D shows a left sideview of an embodiment of a planar towelette with a wiping element on the lower right corner on only the front face.

FIG. 4E shows a right sideview of an embodiment of a planar towelette with a wiping element on the lower right corner on only the front face.

FIG. 4F shows a lower edge sideview of an embodiment of a planar towelette with a wiping element on the lower right corner on only the front face.

FIG. 4G shows an upper edge sideview of an embodiment of a planar towelette with a wiping element on the lower right corner on only the front face.

FIG. 5 shows perspective view of an embodiment of a plurality of towelettes formed into a continuous roll.

FIG. 6 shows perspective view of an embodiment of a planar towelette with a wiping element on the lower right corner in use to remove unwanted waste matter that has congealed and firmly affixed itself to the exterior of a vehicle

FIG. 7A shows a front view of an embodiment of wiping elements on the lower edge and upper edge on the front face.

FIG. 7B shows a back view of an embodiment of a planar towelette with wiping elements on the lower edge and upper edge on the front face.

FIG. 7C shows a left sideview of an embodiment of a planar towelette with wiping elements on the lower edge and upper edge on the front face.

FIG. 7D shows a right sideview of an embodiment of a planar towelette with wiping elements on the lower edge and upper edge on the front face.

FIG. 7E shows a lower edge sideview of an embodiment of a planar towelette with wiping elements on the lower edge and upper edge on the front face.

FIG. 7F shows an upper edge sideview of an embodiment of a planar towelette with wiping elements on the lower edge and upper edge on the front face.

FIG. 8A shows a front view of an embodiment of a wiping element on the lower left corner on only the front face.

FIG. 8B shows a back view of an embodiment of a planar towelette with a wiping element on the lower left corner on only the front face.

FIG. 8C shows a left sideview of an embodiment of a planar towelette with a wiping element on the lower left corner on only the front face.

FIG. 8D shows a right sideview of an embodiment of a planar towelette with a wiping element on the lower left corner on only the front face.

FIG. 8E shows a lower edge sideview of an embodiment of a planar towelette with a wiping element on the lower left corner on only the front face.

FIG. 8F shows an upper edge sideview of an embodiment of a planar towelette with a wiping element on the lower left corner on only the front face.

FIG. 9A shows a front view of an embodiment of wiping elements on both the lower left corner on the front face.

FIG. 9B shows a back view of an embodiment of a planar towelette with wiping elements on both the lower left corner on the front face.

FIG. 9C shows a left sideview of an embodiment of a planar towelette with wiping elements on both the lower left corner on the front face.

FIG. 9D shows a right sideview of an embodiment of a planar towelette with wiping elements on both the lower left corner on the front face.

FIG. 9E shows a lower edge sideview of an embodiment of a planar towelette with wiping elements on both the lower left corner on the front face.

FIG. 9F shows an upper edge sideview of an embodiment of a planar towelette with wiping elements on both the lower left corner on the front face.

FIG. 10A shows a front view of an embodiment of wiping elements on both the upper edge and the lower left corner on the front face.

FIG. 10B shows a back view of an embodiment of a planar towelette with wiping elements on both the upper edge and the lower left corner on the front face.

FIG. 10C shows a left sideview of an embodiment of a planar towelette with wiping elements on both the upper edge and the lower left corner on the front face.

FIG. 10D shows a right sideview of an embodiment of a planar towelette with wiping elements on both the upper edge and the lower left corner on the front face.

FIG. 10E shows a lower edge sideview of an embodiment of a planar towelette with wiping elements on both the upper edge and the lower left corner on the front face.

FIG. 10F shows an upper edge sideview of an embodiment of a planar towelette with wiping elements on both the upper edge and the lower left corner on the front face.

FIG. 11A shows a front view of an embodiment of wiping elements on the upper edge on the front face and the lower left corner on the back face.

FIG. 11B shows a back view of an embodiment of a planar towelette with wiping elements on the upper edge on the front face and the lower left corner on the back face.

FIG. 11C shows a left sideview of an embodiment of a planar towelette with wiping elements on the upper edge on the front face and the lower left corner on the back face.

FIG. 11D shows a right sideview of an embodiment of a planar towelette with wiping elements on the upper edge on the front face and the lower left corner on the back face.

FIG. 11E shows a lower edge sideview of an embodiment of a planar towelette with wiping elements on the upper edge on the front face and the lower left corner on the back face.

FIG. 11F shows an upper edge sideview of an embodiment of a planar towelette with wiping elements on the upper edge on the front face and the lower left corner on the back face.

### DETAILED DESCRIPTION OF THE INVENTION

Reference is made herein to the attached drawings. Like reference numerals are used throughout the drawings to depict like or similar elements of the supply of planar towelettes. For the purposes of presenting a brief and clear description of the present invention, the preferred embodiment will be discussed as used for the supply of planar towelettes. The figures are intended for representative purposes only and should not be considered to be limiting in any respect.

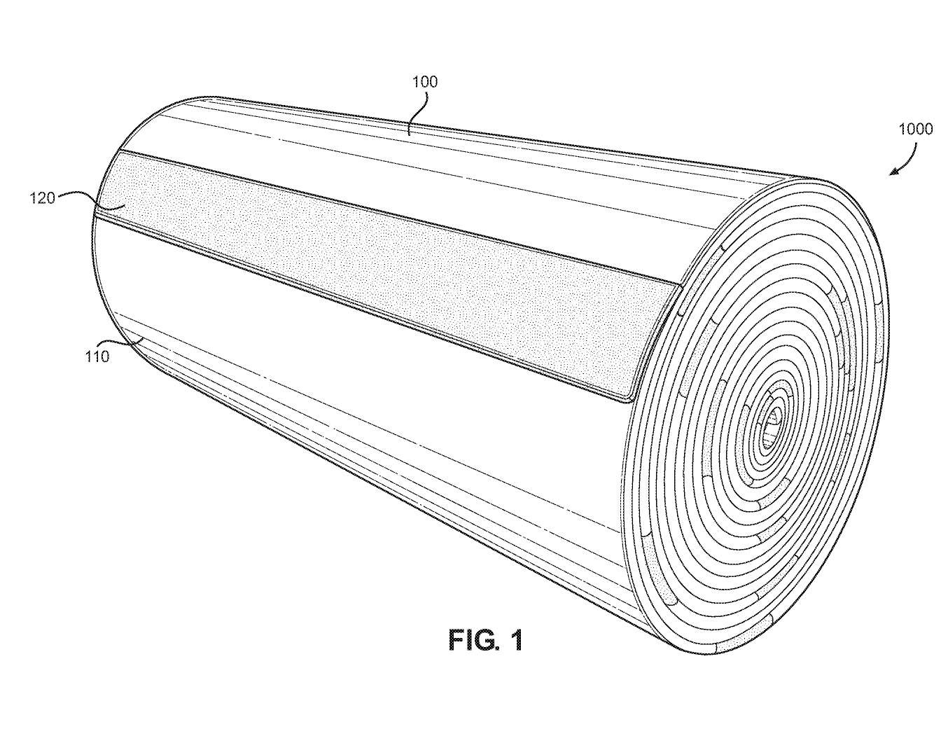

Referring now to FIG. 1, there is shown a perspective view of an embodiment of a supply of planar towelettes. The supply of planar towelettes 1000, comprises a plurality of planar towelettes 100, such that each towelette 100 further comprises a flexible and absorbent cloth-like material 110, and at least one wiping element 120 disposed thereon. The wiping element 120 is a hardened fabric with thin edges configured to scrape and remove dirt and debris from a surface. In the illustrated embodiment the wiping element 120 is longitudinal and positioned along the lowermost edge of the planar towelette 100 and is made from a flexible natural rubber material, such that it can be more easily manipulated when cleaning a surface. In other embodiments the wiping element 120 can be made from a silicone compound to make the device more durable, which thereby allows each planar towelette 100 to be used more abrasively when wiping.

Additionally, the absorbent cloth-like material 110 is made from a blend of polyester and wood pulp to stand up to more vigorous scrubbing, and is configured to receive a cleaning solution either by means of impregnation or by coating the surface.

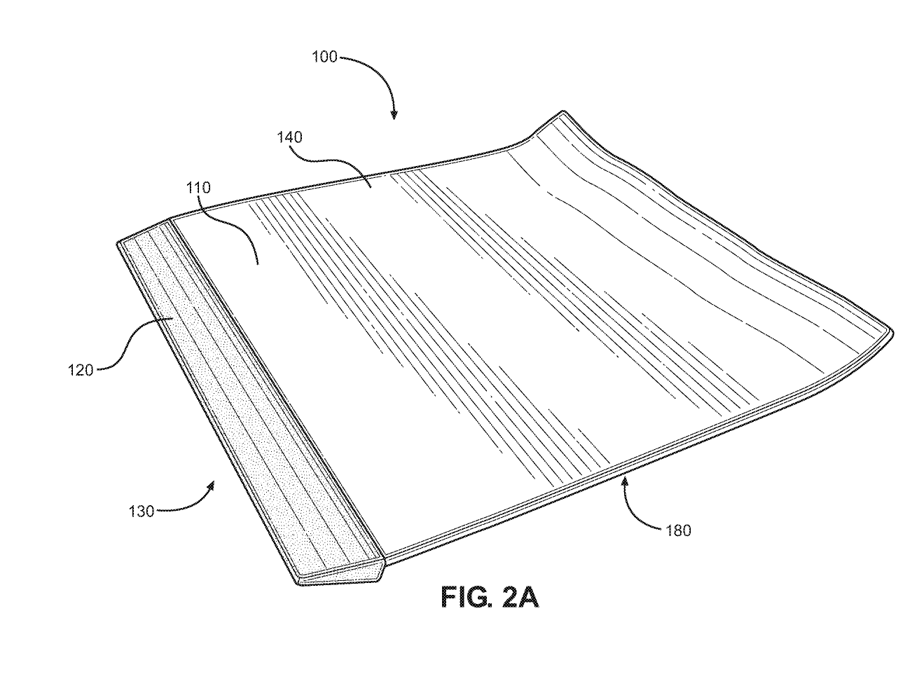

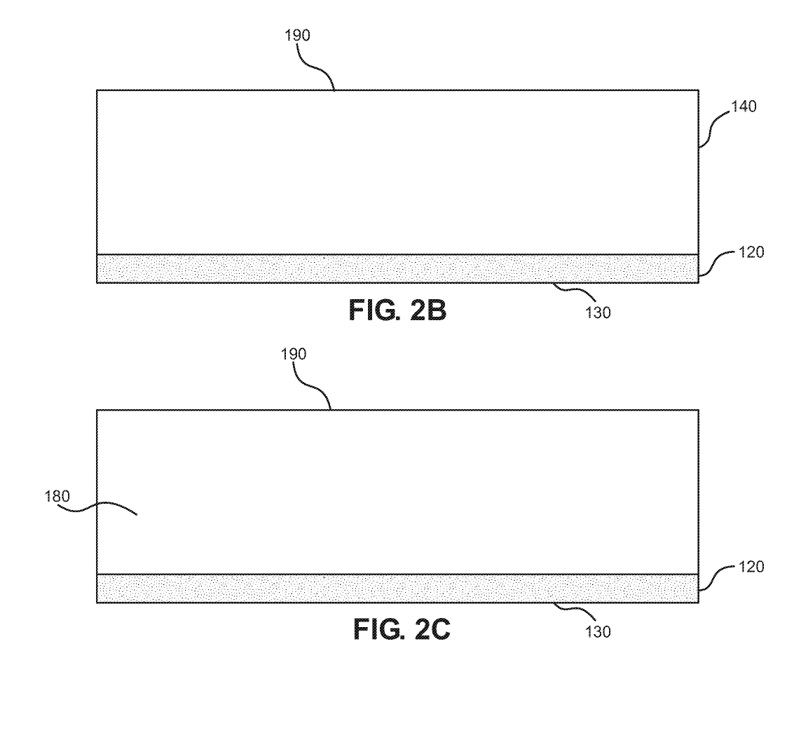

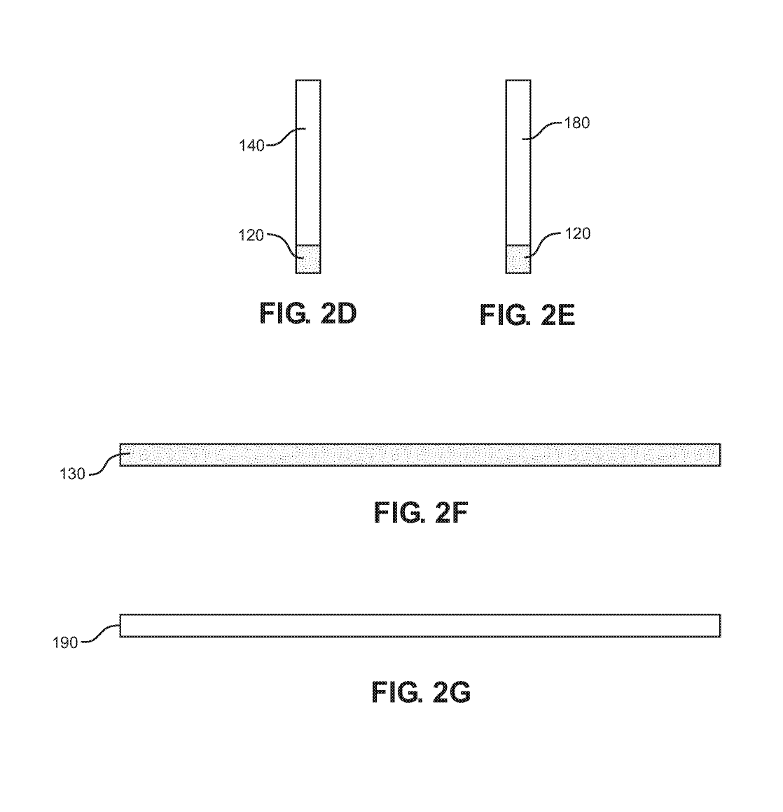

Referring now to FIGS. 2A-G there are shown a perspective view, a front view, a back view, a left sideview, a right sideview, a lower edge sideview, and an upper edge sideview of an embodiment of a planar towelette with a wiping element disposed on the lower edge on both front and back faces, respectively. The planar towelette 100 further includes a front face 140 and a back face 180. In the illustrated embodiment the wiping element 120 is disposed along the lower longitudinal edge 130 on both the front face 140 and the back face 180 for added strength and thickness. Such a configuration provides a reinforced wiping element 120 that can be used when scraping or removing harder to deal with sections of dirt or congealed refuse. In the shown embodiment, the wiping element 120 includes a wedge, having a triangular cross section, including a first end that is directly affixed with both the front face 140 and the back face 180, and tapering toward a narrower leading edge. The leading edge is configured to engage between a surface and an object resting thereon, for the purposes of causing separation therewith. The flush edge formed by the wiping element 120 and both the front face 140 and the back face 180 provides for reversible usage thereof. In other embodiments the wiping element 120 can be disposed along a different edge of the planar towelette 100, may be limited to only the front face 140, or may disposed on the back face 180 instead of being installed on both face to reduce the costs of material and manufacture.

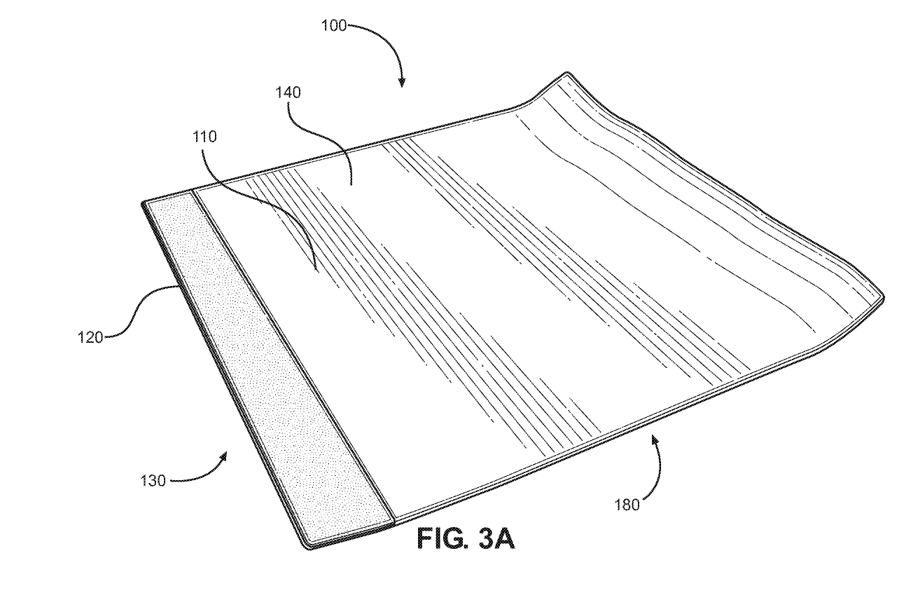

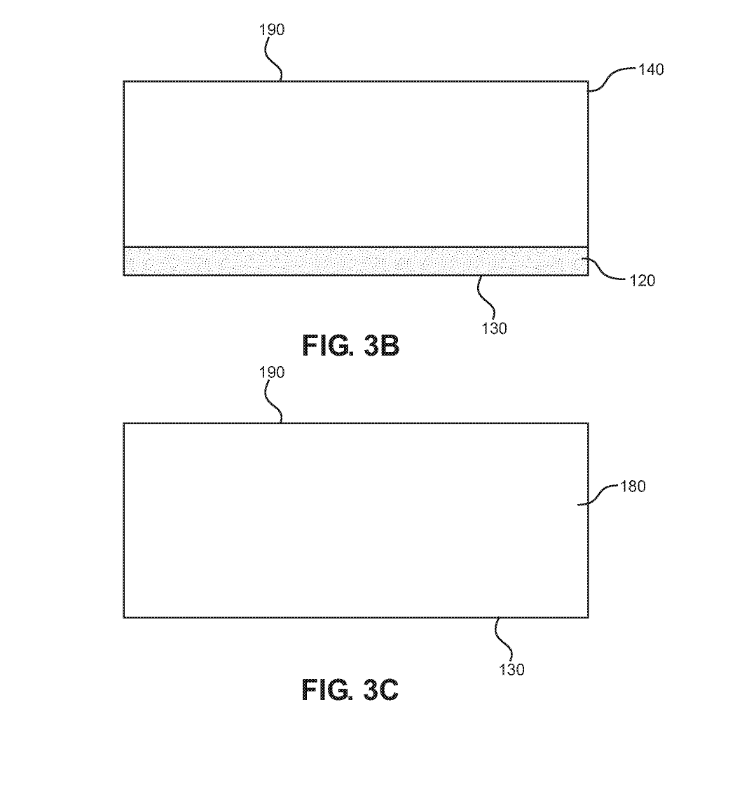

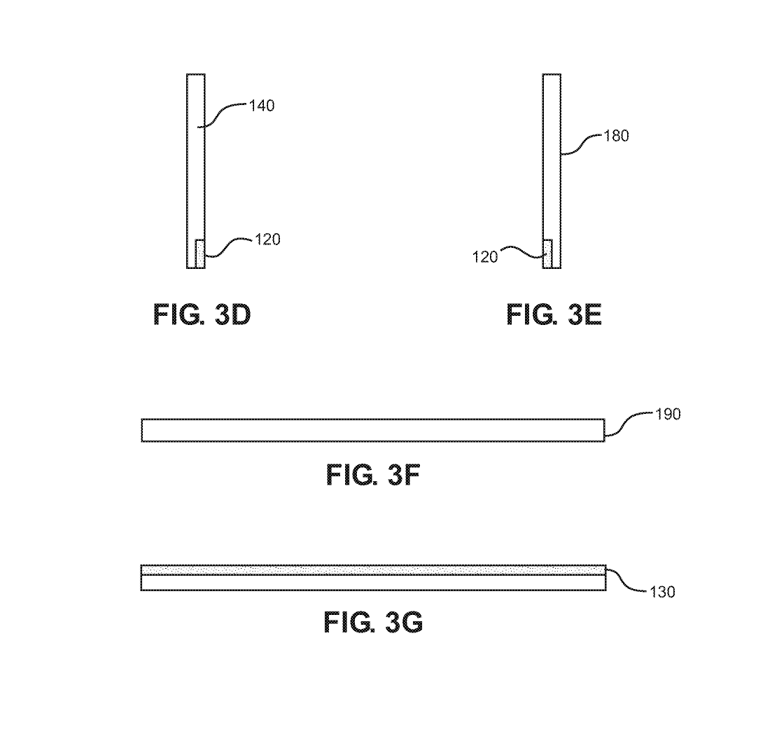

Referring now to FIGS. 3A-G, there are shown a perspective view, a front view, a back view, a left sideview, a right sideview, a lower edge sideview, and an upper edge sideview of an embodiment of a planar towelette with a wiping element on the lower edge on only the front face, respectively. Here, the wiping element 120 is again installed on the lower longitudinal edge 130. However, in this embodiment the wiping element is included on the front face 140 while the back face 180 is bare. This shows that a functional embodiment of the planar towelette 100 can be produced with at least one wiping element 120 disposed on either the front face 140 or the back face 180.

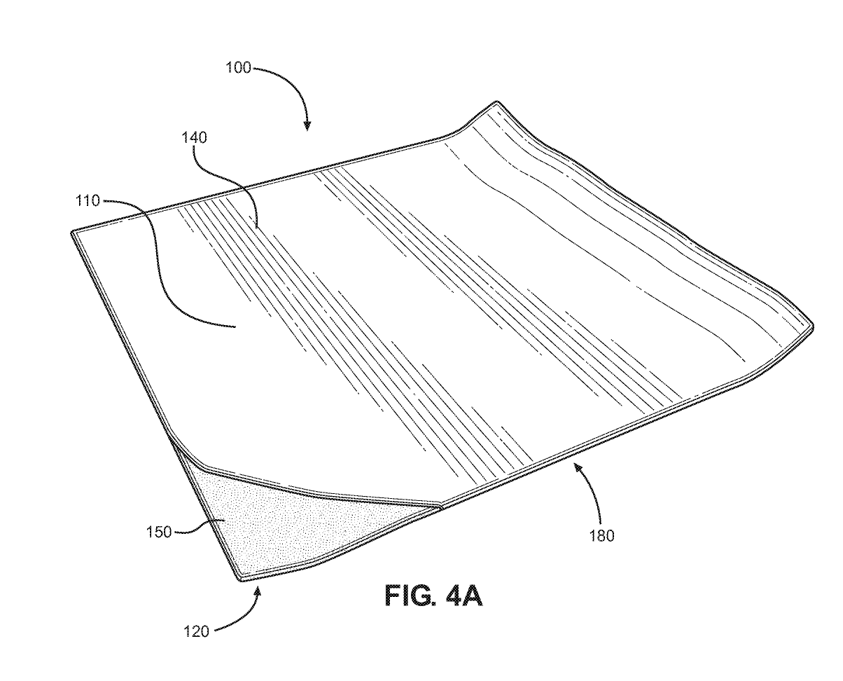

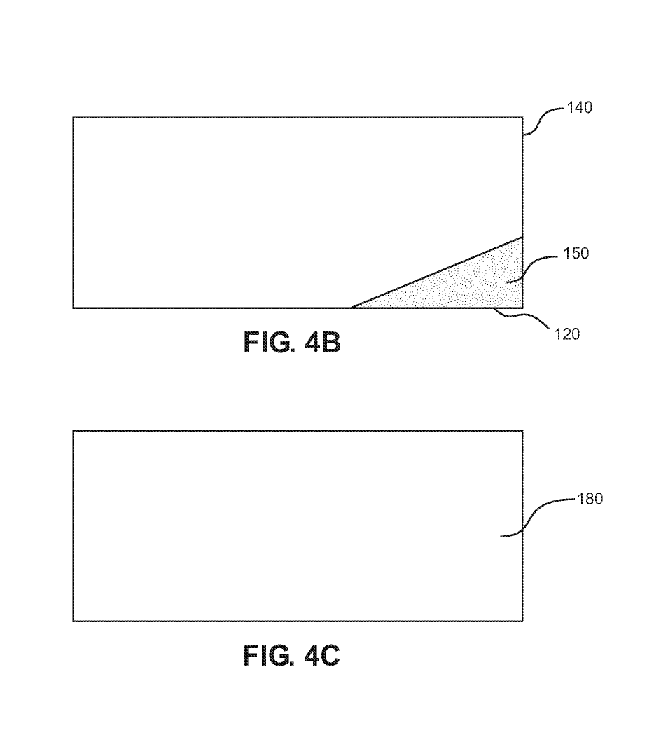

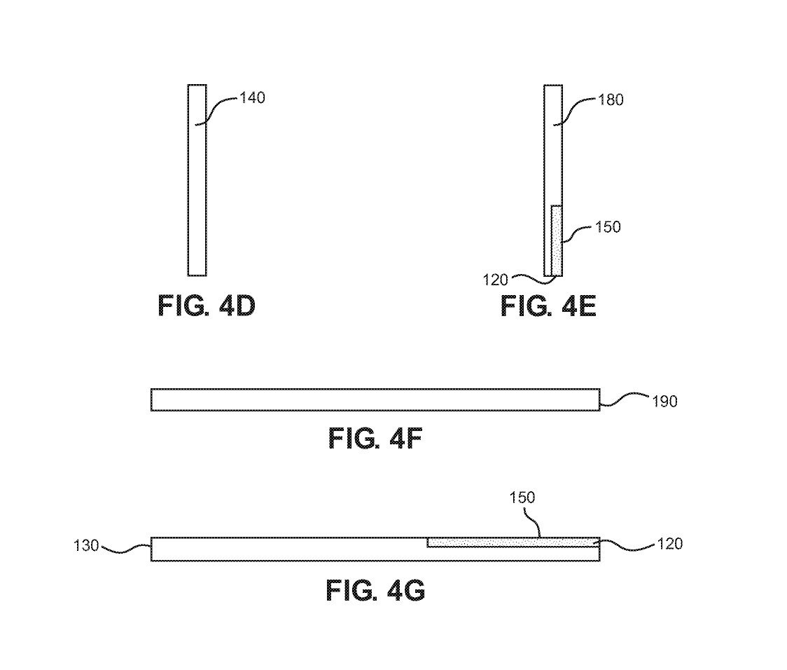

Referring now to FIGS. 4A-G, there are shown a perspective view, a front view, a back view, a left sideview, a right sideview, a lower edge sideview, and an upper edge sideview of an embodiment of a planar towelette with a wiping element on the lower right corner on only the front face, respectively. In the embodiment of a planar towelette 100 illustrated here, the wiping element 120 is triangular in shape and disposed on the lower right corner 150 of the front face 140 only. The triangular shape takes up less surface area on the face of the planar towelette 100. Smaller overall size allows for easier one-handed manipulation of the wiping element 120.

Here, the back face 180 is again bare to again show that a functional embodiment of the planar towelette 100 can be produced with at least one wiping element 120 disposed on either the front face 140 or the back face 180, and to further show that the wiping element 120 can also be installed on the corners 150 of the planar towelette 100 and need not take up an entire edge 130.

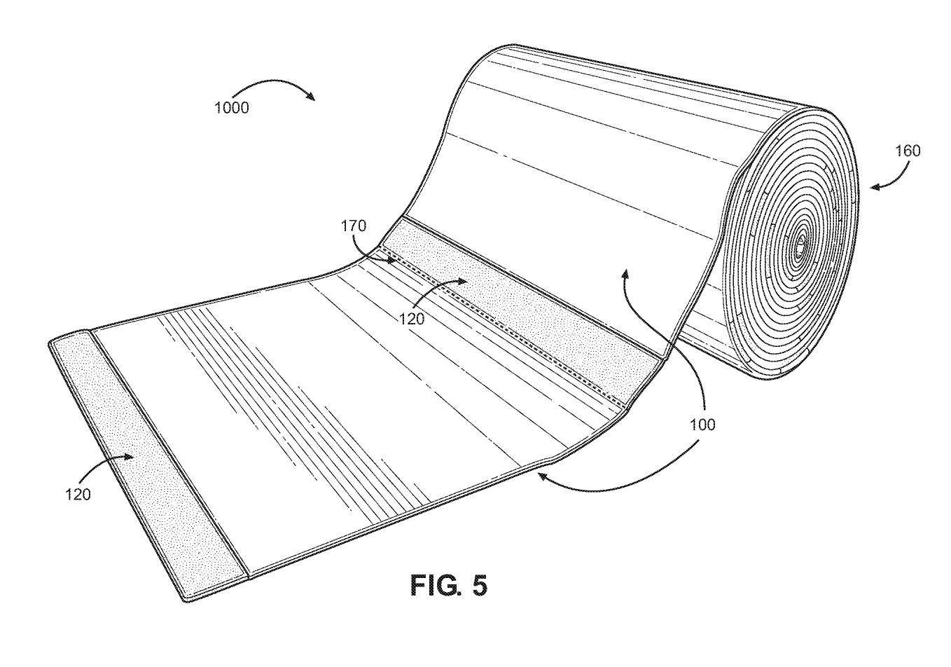

Referring now to FIG. 5, there is shown a perspective view of an embodiment of a plurality of towelettes formed into a continuous roll. In the illustrated embodiment the supply of planar towelettes 1000 is provided in the form of a continuous, spirally wound roll of planar towelettes 160, such that each towelette 100 is rectangular shaped with wiping elements 120 disposed on the lower edge 130 of the front face 140. Furthermore, each planar towelette 101 in the continuous roll of planar towelettes 160 is separably interconnected to the next planar towelette 102 in sequence by means of perforation lines 170. The perforation lines 170 are drawn between the unadorned upper edge of the instant planar towelette 101 and the lower edge with a wiping element 120 of the next planar towelette 102, such that each towelette can be individually removed. In one embodiment, the perforation lines are weakened lines formed by a series of apertures therealong, such that an application of a force, such as a shearing force, causes the separation of the adjacent toilette 101, 102. Having the planar towelettes 100 be rectangular in shape with the wiping element 120 positioned along the lower longitudinal edge 130 of the front face 140 and cutting the perforation line 170 along the lower longitudinal edge 130 simplifies the manufacturing process for continuous rolls of planar towelettes 160.

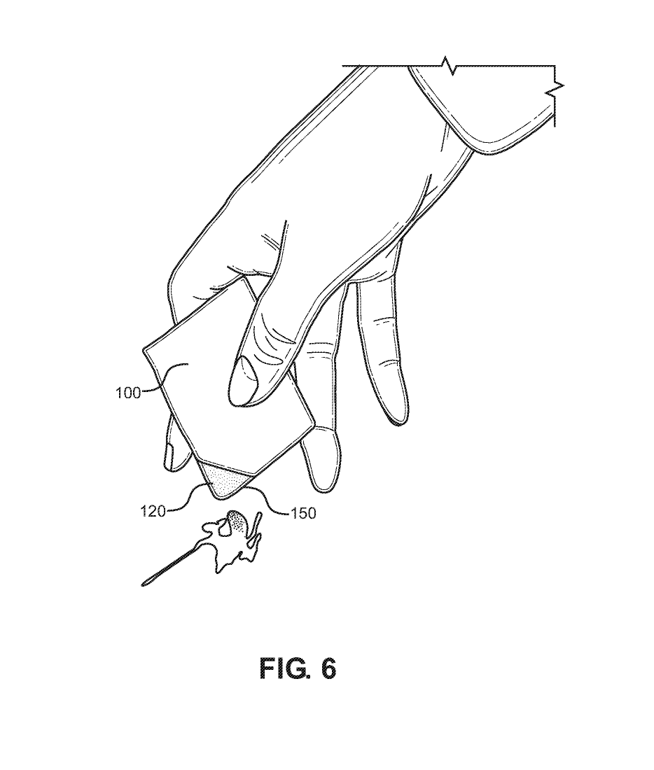

Referring now to FIG. 6, there is shown a perspective view of an embodiment of a planar towelette with a wiping element on the lower right corner in use to remove unwanted waste matter that has congealed and firmly affixed itself to the exterior of a vehicle. Here, the planar towelette 100 is a smaller embodiment with a triangular wiping element 120 disposed on a corner 150 on the front face 140. As discussed earlier the smaller size allows for easier one-handed manipulation of the wiping element 120. To best remove these congealed substances the hardened and thin edges of the wiping element 120 can be pressed down at an angle to the surface being cleaned and then repeatedly struck against the base of the substance in a back and forth motion to create a gap between the substance and the surface until the two are fully separated.

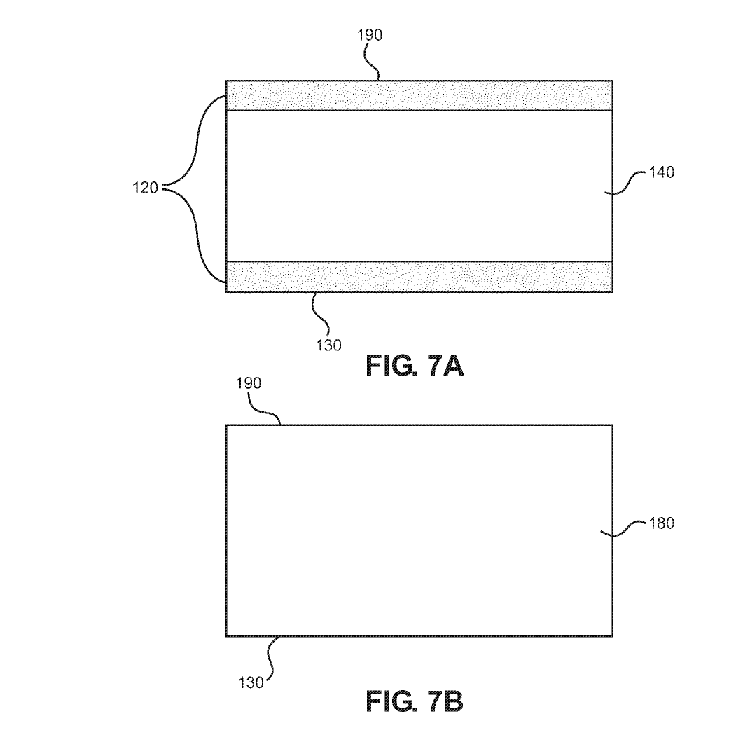

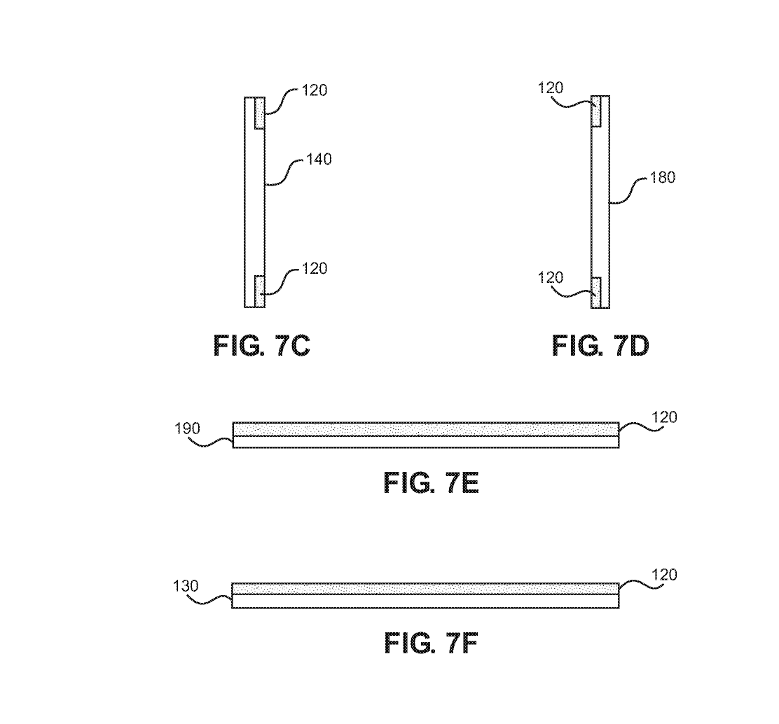

Referring now to FIGS. 7A-F, 8A-F, 9A-F, 10A-F, and 11A-F there is shown a front view , a back view, a left sideview, a right sideview, a lower edge sideview, and an upper edge sideview of an embodiment of a planar towelette with wiping elements on the lower edge and upper edge on the front face, respectively; a front view a back view, a left sideview, a right sideview, a lower edge, and an upper edge sideview of an embodiment of a planar towelette with a wiping element on the lower left corner on only the front face, respectively; a front view a back view, a left sideview, a right sideview, a lower edge sideview, and an upper edge sideview of an embodiment of a planar towelette with wiping elements on both the lower left corner on the front face, respectively; a front view, back view, a left sideview, a right sideview, a lower edge, and an upper edge sideview of an embodiment of a planar towelette with wiping elements on both the upper edge and the lower left corner on the front face, respectively; a front view, a back view, a left sideview, a right sideview, a lower edge sideview, and an upper edge sideview of an embodiment of a planar towelette with wiping elements on the upper edge on the front face and the lower left corner on the back face. The five shown examples are not exhaustive, but merely serve to illustrate the variety of design options available when combining multiple wiping elements that can be installed along the edges and/or corners on the front face 140 or back face 180 of the planar towelettes 100.

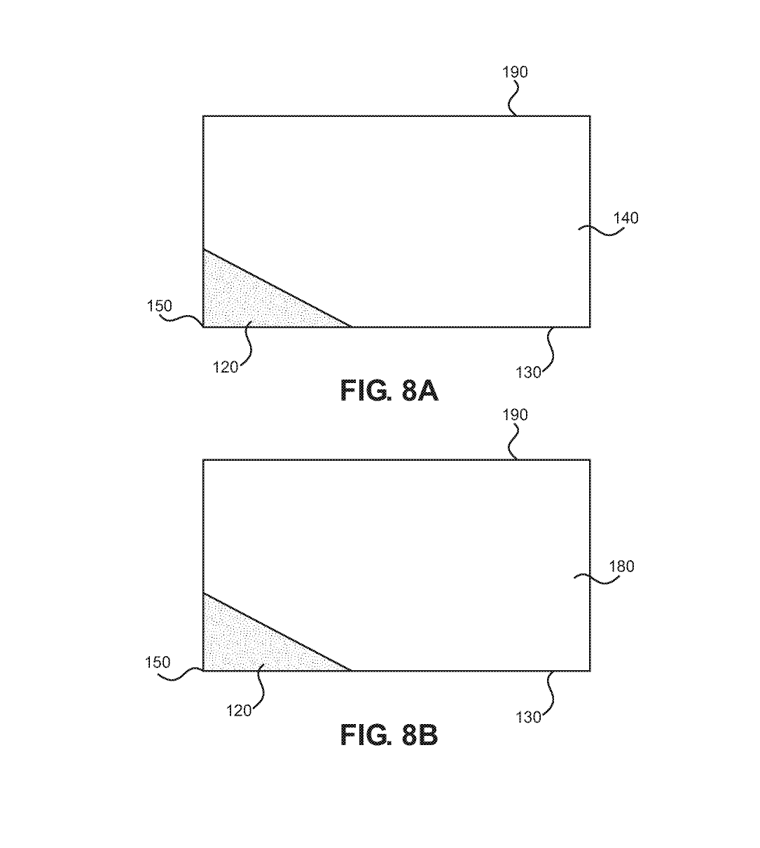

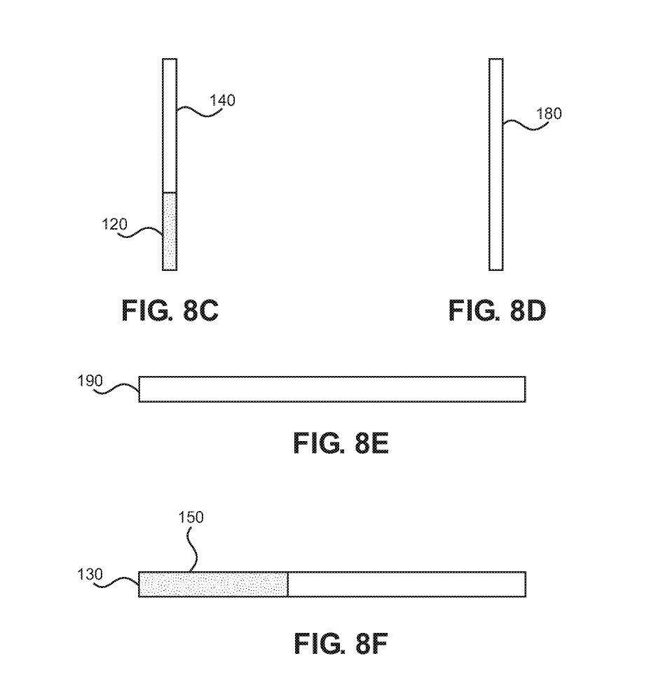

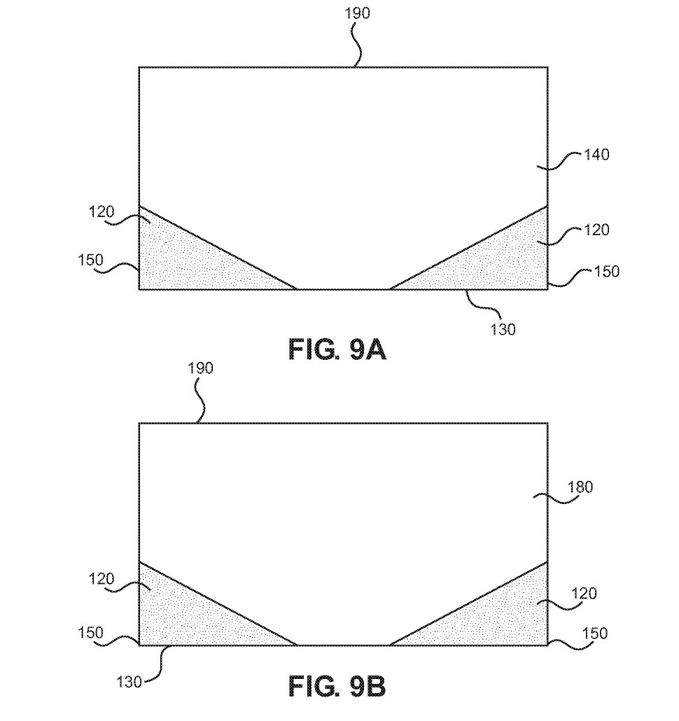

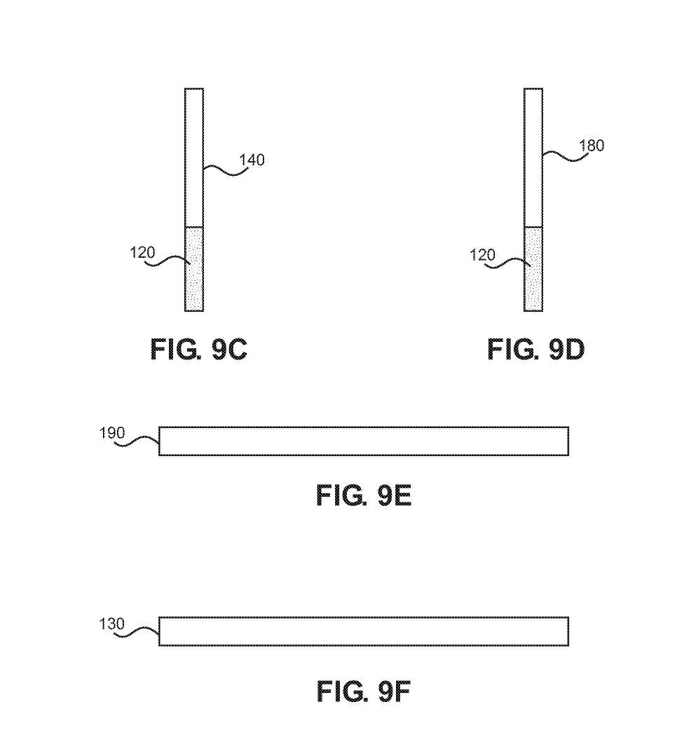

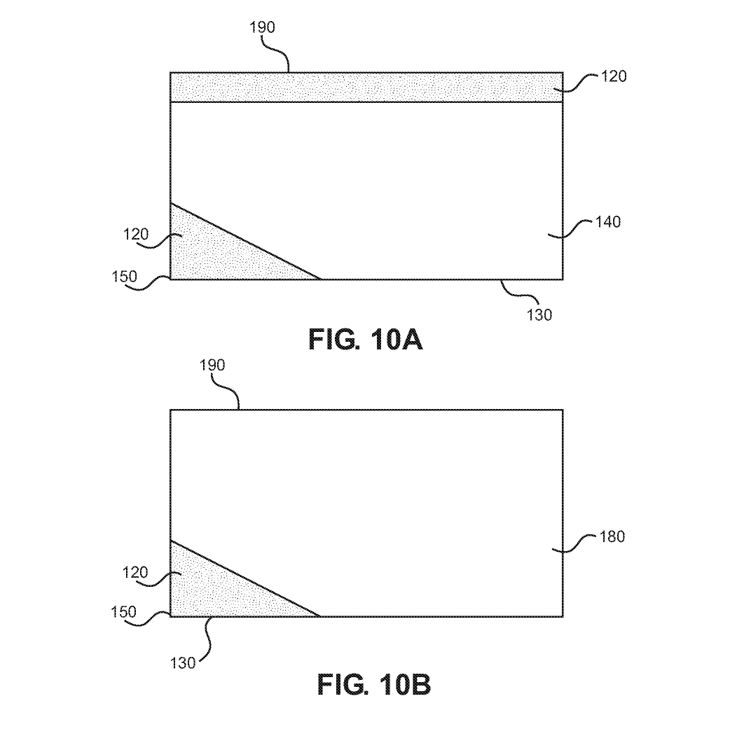

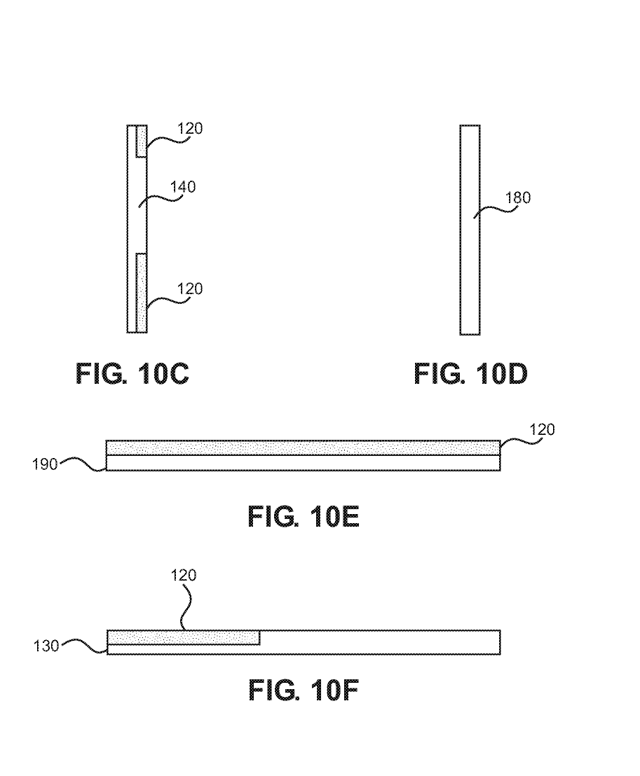

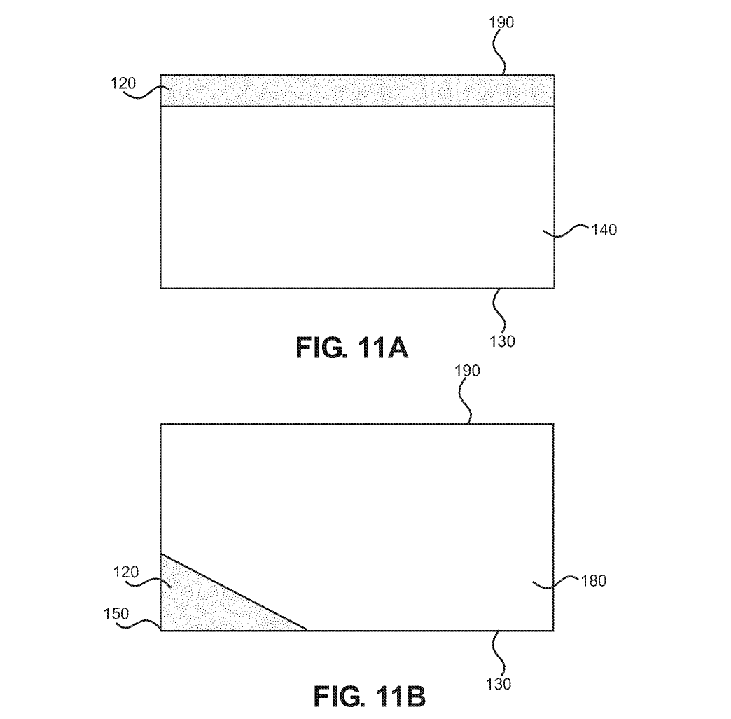

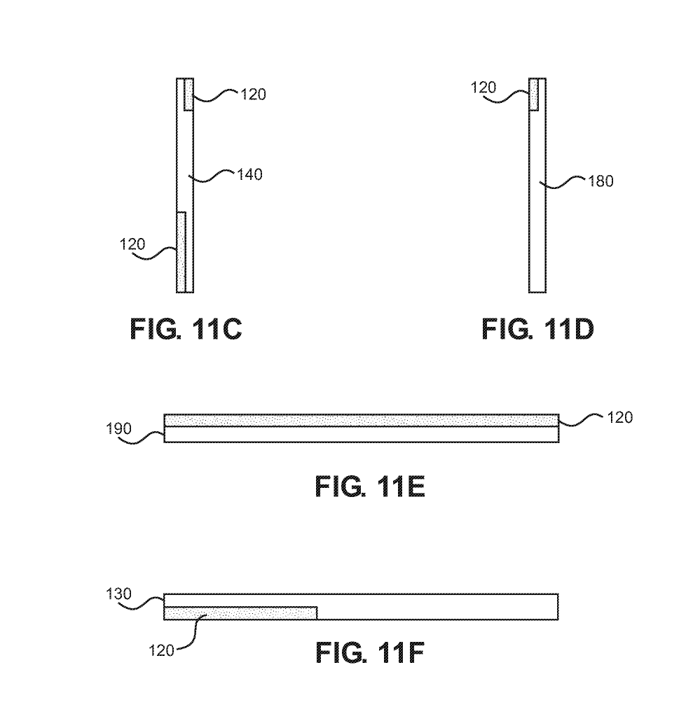

The first embodiment in FIGS. 7A-F shows two wiping elements of the longitudinal edge variety installed along the top and bottom edges of the front face only. This configuration increases the number of uniquely positioned wiping elements, which therefore also increases the number of possible scraping/removal attempts that can be made with a single towelette. The second embodiment in FIGS. 8A-F shows two wiping elements of the triangular variety installed on the left lower edge on both the front and back faces to create a reinforced wiping element. The third embodiment in FIGS. 9A-F shows four wiping elements of the triangular variety installed on the left and right lower edges on both the front and back faces to create a pair of reinforced wiping elements. This configuration offers the increased strength of reinforced wiping elements and increases the number of possible scraping/removal attempts that can be made with a single towelette. The fourth embodiment in FIGS. 10A-F shows two wiping elements, one of the edge variety and the other of the triangular variety where both being installed on the front face of the towelette. The fifth embodiment in FIGS. 11A-F again shows two wiping elements, one of the edge variety and the other of the triangular variety. Where the edge element is installed on the upper edge of front face of the towelette and the triangular element is installed on the lower left corner of the back face of the towelette.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A towelette with wiping element, comprising;
a planar towelette including a flexible absorbent material, and at least one wiping element disposed thereon;
the flexible absorbent material being configured to receive a cleaning solution therein;
the wiping element comprising a hardened fabric with thin edges configured to scrape and remove congealed dirt and debris from a surface.

2. The towelette with wiping element of claim 1, wherein the wiping element is disposed along the edge of at least one side of the planar towelette.

3. The towelette with wiping element of claim 1, wherein the wiping element is an elongated strip longitudinally disposed across the face of at least one face of the planar towelette.

4. The towelette with wiping element of claim 1, wherein the wiping element is triangular in shape and disposed on one or more corners on at least one face of the planar towelette.

5. The towelette with wiping element of claim 1, wherein the towelette is rectangular in shape.

6. The towelette with wiping element of claim 5, wherein a plurality of towelettes form a continuous roll.

7. The towelette with wiping element of claim 6, wherein the continuous roll of towelettes are separably interconnected via a perforation line, such that each towelette can be individually removed.

8. The towelette with wiping element of claim 1, wherein the absorbent material is impregnated with cleaning solution.

9. The towelette with wiping element of claim 1, wherein the surface of the absorbent material is coated by a layer of cleaning solution.

10. The towelette with wiping element of claim 1, wherein the wiping element comprises a flexible natural rubber material.

11. The towelette with wiping element of claim 1, wherein an elongated wiping element is longitudinally disposed across the lower edge of the front face of the planar towelette.

12. The towelette with wiping element of claim 1, wherein a triangular wiping element is disposed on the lower right corner of the front face of the planar towelette.

13. The towelette with wiping element of claim 1, wherein two elongated wiping elements are longitudinally disposed across both the lower edge and the upper edge of the front face of the planar towelette.

14. The towelette with wiping element of claim 1, wherein two triangular wiping elements are disposed on the lower left corner of the front face and the lower left corner of the back face of the planar towelette.

15. The towelette with wiping element of claim 1, wherein two triangular wiping elements are disposed on the lower left corner of the front face and the lower left corner of the back face of the planar towelette, and two triangular wiping elements are disposed on the lower right corner of the front face and the lower right corner of the back face of the planar towelette.

16. The towelette with wiping element of claim 1, wherein a first wiping element is disposed on the lower left corner of the front face of the planar towelette, and a second wiping element is longitudinally disposed across an upper edge of the front face of the planar towelette.

17. The towelette with wiping element of claim 1, wherein a first wiping element is disposed on the lower left corner of the back face of the planar towelette, and a second wiping element is longitudinally disposed across an upper edge of the front face of the planar towelette.
